(19) United States
(12) Patent Application Publication
(10) Pub. No.: US 2013/0173430 A1
(43) Pub. Date: Jul. 4, 2013

(54) COMPUTER PROGRAM, METHOD, AND SYSTEM FOR INVENTORY MANAGEMENT AND POINT OF SALE

(71) Applicant: INVENQUERY, LLC, Prairie Village, KS (US)

(72) Inventor: Nathan Benjamin, Kansas City, MO (US)

(73) Assignee: INVENQUERY, LLC, Prairie Village, KS (US)

(21) Appl. No.: 13/724,562

(22) Filed: Dec. 21, 2012

Related U.S. Application Data
(60) Provisional application No. 61/581,312, filed on Dec. 29, 2011.

(51) Int. Cl. G06Q 10/08

(52) U.S. Cl. CPC G06Q 10/087; G06Q 30/0627
USPC 705/26.63

(57) ABSTRACT

A computer program, method, and system for managing, marketing, and selling an inventory of unique items. In more detail, the computer program, method, and system provide for the managing, marketing, and selling of an inventory of unique items, such as small-quantity or single-quantity items that are difficult and/or time-consuming to individually register and categorize.

### RELATED APPLICATIONS

This patent application claims priority benefit, with regard to all common subject matter, of earlier-filed U.S. Provisional Patent Application No. 61/581,312, filed Dec. 29, 2011, and entitled “COMPUTER PROGRAM, METHOD, AND SYSTEM FOR INVENTORY MANAGEMENT & POINT OF SALE.” The identified earlier-filed provisional patent application is hereby incorporated by reference in its entirety into the present application.

### FIELD

Embodiments of the present invention provide a computer program, method, and system for managing, marketing, and selling an inventory of unique items. In more detail, embodiments of the present invention are directed to a computer program, method, and system for managing, marketing, and selling an inventory of unique items, such as small-quantity or single-quantity items that are difficult and/or time-consuming to individually register and categorize.

### BACKGROUND

Small or single-quantity unique items, such as surplus construction materials from construction sites, materials salvaged from remodeling projects, or excess materials stored in warehouses are often disposed of and needlessly wasted. To avoid disposing and wasting unique items that can potentially be reused, there exists markets for donations, sales, and/or re-sales of such unique items. In certain cases, the unique items are sold via online retail websites, such as Ebay™, Craigslist™, or the like. In certain other cases, brick and mortar retail stores are established to intake, process, and sell the unique items.

Regardless of the mode of sale of the unique items, processing and inventory management of the unique items is a manual exercise. Because the unique items are often donated or sold by entities that determine at the last minute that the unique items are surplus or salvage, it is often difficult to forecast the types of unique items that will be donated or sold to the retail websites and stores. Thus, there is no convenient and organized solution for the retail websites and stores to inform customers of unique items that are currently available for purchase without the customers physically visiting the stores or warehouses. Once the unique items are received by the retail websites and/or stores, it is time consuming for the retail website and/or stores to manually inventory each unique item due to the unique items generally being small-quantity or single-quantity items. This results in the unique items simply being generally categorized (e.g., “kitchen cabinets” or “chandelier”) or displayed (e.g., “items similar to what we typically have in our inventory”). Such generalization is common for both online retail websites and in brick and mortar retail stores. In addition, many brick and mortar retail stores do not have online inventory systems because unique items are difficult to upload and track via common inventory systems. Unique items that are marketed online are oftentimes advertised with standardized photos with general comments like “items we typically have.” Such marketing requires potential customers to visit the brick and mortar retail store in person to see which unique items may actually be available.

Because inventory is constantly changing, potential customers must visit the brick and mortar retail stores repeatedly to view the changing inventory. For brick and mortar retail stores that want to include online sales options, the brick and mortar retail stores must manually update unique items (post items as they come in and remove when an item sells). However, potential customers have no assurance that the unique items that they are attempting to reserve or purchase online are available because the unique items may have already been purchased by another customer from the brick and mortar retail store but the online inventory was not yet updated. Similarly, potential customers to the brick and mortar retail store have no assurance that the unique item that they are attempting to purchase from the brick and mortar retail store are available for purchase because the unique items may have already been purchased by another customer online but the inventory was not yet updated.

### SUMMARY

Embodiments of the present invention provide for a computer program, method, and system directed to the managing, marketing, and selling of inventories of unique items. In more detail, embodiments of the present invention include a method comprising the steps of receiving a request or instruction for a new unique item to be registered in an inventory database. Upon receiving the request for the new unique item to be registered, the new unique item is assigned a unique item identifier, and the new unique item is registered in the inventory database. Thereafter, attribute information associated with the new unique item is received and stored in the inventory database. A user interface is generated on an electronic display of a user's computing device, and embodiments of the present invention include receiving a request or instruction from the user to search a plurality of unique items registered in the inventory database for unique items whose attribute information matches a search criteria. In response to searching the inventory database, embodiments of the present invention present to the user, via the user interface, attribute information for the unique items whose attribute information matches the search criteria. In certain instances, the attribute information of the new unique item may be included in the attribute information presented to the user. Finally, embodiments of the present invention include receiving a request or instruction for the new unique item to be unregistered from the inventory database, such that upon receiving such the request, the new unique item is unregistered from the inventory database, and the attribute information of the new unique item is no longer available to be presented to the user.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a flow chart of a method of managing inventories of unique items according to embodiments of the present invention; and

FIG. 2 is a schematic depiction of a system for managing inventories of unique items in accordance with embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides various embodiments of a computer program, a method, and a system for managing, marketing, and selling an inventory of unique items. As used herein, unique items may generally be defined as small-quantity or single-quantity items that may be difficult to inventory and manage because each item must be individually registered and categorized. However, it is understood that embodiments of the present invention may also be directed to large-quantity or mass-quantity items that are easier to register and categorize because each may have similar characteristics and/or attributes. Thus, although embodiments of the present invention are broadly directed at managing, marketing, and selling small-quantity or single-quantity items, embodiments of the present invention may also be directed to large or mass-quantity items.

The computer program, method, and system of embodiments of the present invention provide an online resource, such as an online or a mobile application, which allows a user to manage inventories of unique items, to market the unique items, and to sell the unique items. As a non-limiting example, embodiments of the present invention can be implemented to manage, market, and sell unique items for a single retail store. Embodiments of the present invention directed to such an implementation are hereinafter referred to as single store embodiments. As another non-limiting example, embodiments of the present invention may be implemented to manage, market, and sell unique items across multiple retail stores. Embodiments of the present invention directed to such an implementation are hereinafter referred to as multi-store embodiments. In even additional embodiments of the present invention, the computer program, method, and system may be implemented for use by groups of single retail stores and/or groups of multiple retail stores. Such embodiments may be referred to as multi-tenant embodiments. In such embodiments, the computer program, method, and system may be implemented and hosted by a hosting entity, and each group of single and/or multiple retail stores may establish and operate, via the hosting entity, a unique embodiment of the present invention to manage, market, and sell their inventories of unique items.

It is understood that embodiments of the present invention provide for the management, marketing, and sale of unique items for both online retail websites, such as e-commerce sites, and from physical brick and mortar retail stores. Thus, unless specifically referred to as “online” or “brick and mortar,” it is understood that the term retail store encompasses both online and brick and mortar retail stores. In addition, retail stores may also include warehouses, regional inventories, or similar entities and facilities that may store or house inventories of unique items.

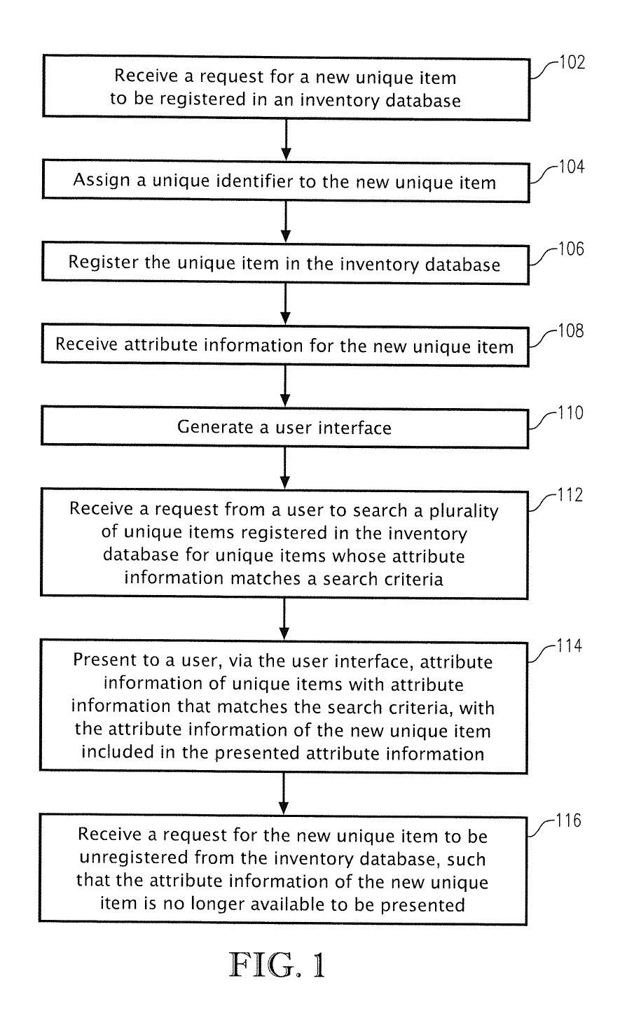

As illustrated in FIG. 1, embodiments of the present invention may include a method with an initial Step 102 of receiving a request or instruction for a new unique item to be registered in an inventory database. Upon receiving the request for the new unique item to be registered, the new unique item is assigned to a unique item identifier in Step 104. The new unique item is registered in the inventory database in Step 106. In a next Step 108, attribute information associated with the new unique item is received and stored in the inventory database. Thereafter, in Step 110, a user interface is generated on a computing device of a user, for instance on a computing device of a customer user, as is defined in more detail below. A next Step 112 includes receiving a request or instruction from the user to search a plurality of unique items registered in the inventory database for unique items whose attribute information matches a search criteria. In response to searching the inventory database, a next Step 114 includes presenting to the user via the user interface attribute information for the unique items whose attribute information matches the search criteria. In certain implementations of the method, the attribute information of the new unique item may be included in the attribute information presented to the user. A final Step 116 includes receiving a request or instruction for the new unique item to be unregistered from the inventory database, such that upon receiving the request, the new unique item is unregistered from the inventory database, and the attribute information of the new unique item is no longer available to be presented to the user. In certain implementations of the method, the request to unregister the new unique item from the inventory database may be associated with the user purchasing the new unique item. It is understood that although a unique item may be unregistered from the inventory database, such that it is no longer available to be displayed to customer users, information related to the unique item may be maintained in the database in the form of a cache, back-up memory, or the like. Such information may still be accessible by certain users, such as employee or administrative users, which are discussed in more detail below. Thus, as used herein, the term unregister(ed) does not necessarily mean that all of the information related to the unique item is completely deleted and/or removed from the inventory database.

The computer program of embodiments of the present invention comprises a plurality of code segments executable by a computing device for performing the steps of the method of the present invention. The steps of the method may be performed in the order shown in FIG. 1, or they may be performed in a different order. Furthermore, some steps may be performed concurrently as opposed to sequentially. Also, some steps may be optional.

### System Description

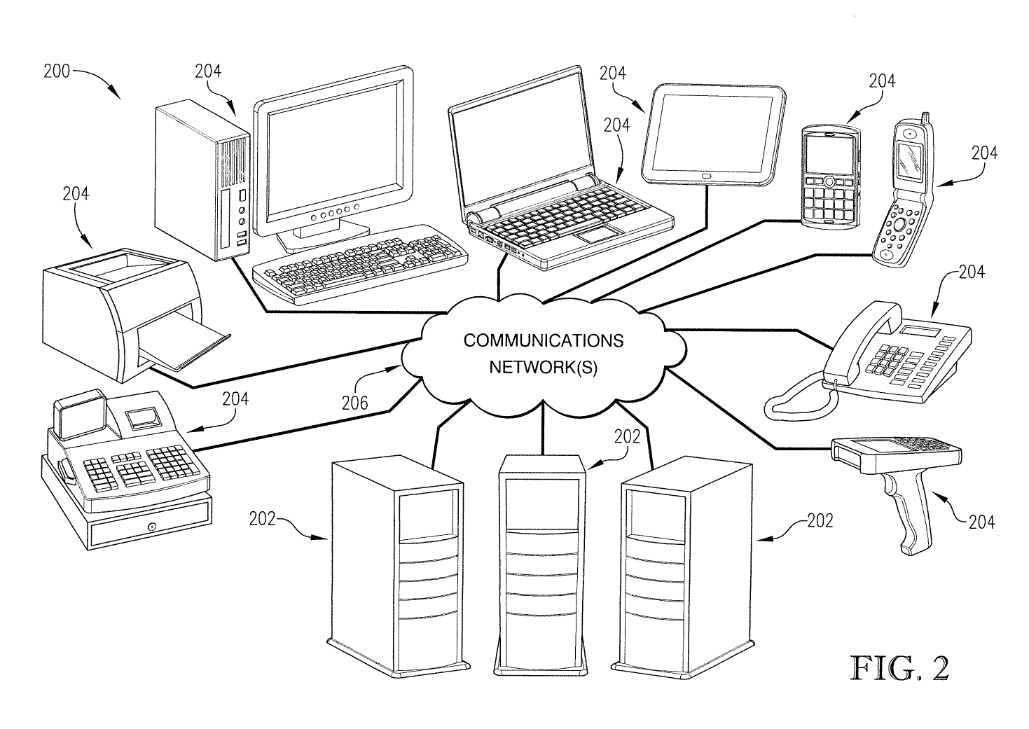

The computer program, system, and method of embodiments of the present invention may be implemented in hardware, software, firmware, or combinations thereof using the unique item inventory management system 200, shown in FIG. 2, which broadly comprises server devices 202, computing devices 204, and a communications network 206. The server devices 202 may include computing devices that provide access to one or more general computing resources, such as Internet services, electronic mail services, data transfer services, and the like. The server devices 202 may also provide access to an inventory database that stores information related to unique items that are inventoried, marketed, and sold in accordance with embodiments of the present invention. The inventory database may also store other information and data necessary for the implementation of the computer program, method, and embodiments of the present invention.

The server devices 202 and computing devices 204 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 202 may further include file stores comprising a plurality of hard disk drives, network attached storage, or a separate storage network.

The computing devices 204 may specifically include mobile communication devices (including wireless devices), work stations, desktop computers, laptop computers, palmtop computers, tablet computers, portable digital assistants (PDA), smart phones, scanners, cash registers, cash drawers, printers, and the like, or combinations thereof. Various embodiments of the computing device 204 may also include voice communication devices, such as cell phones or landline phones. In preferred embodiments, the computing device 204 will have an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or point at display areas to provide information to the user control interface, discussed in more detail below. In additional preferred embodiments, the computing device 204 may include an optical device such as a digital camera, video camera, optical canner, or the like, such that the computing device can capture, store, and transmit digital images and/or videos.

The computing devices 204 may include a user control interface that enables one or more users to share information and commands with the computing devices or server devices 202. The user interface may comprise one or more functionable inputs such as buttons, keyboard, switches, scrolls wheels, voice recognition elements such as a microphone, pointing devices such as mice, touchpads, tracking balls, styluses. The user control interface may also include a speaker for providing audible instructions and feedback. Further, the user control interface may comprise wired or wireless data transfer elements, such as a communication component, removable memory, data transceivers, and/or transmitters, to enable the user and/or other computing devices to remotely interface with the computing device 204.

The communications network 206 may be wired or wireless and may include servers, routers, switches, wireless receivers and transmitters, and the like, as well as electrically conductive cables or optical cables. The communications network 206 may also include local, metro, or wide area networks, as well as the Internet, or other cloud networks. Furthermore, the communications network 206 may include cellular or mobile phone networks, as well as landline phone networks, public switched telephone networks, fiber optic networks, or the like.

Both the server devices 202 and the computing devices 204 may be connected to the communications network 206. Server devices 202 may be able to communicate with other server devices 202 or computing devices 204 through the communications network 206. Likewise, computing devices 204 may be able to communicate with other computing devices 204 or server devices 202 through the communications network 206. The connection to the communications network 206 may be wired or wireless. Thus, the server devices 202 and the computing devices 204 may include the appropriate components to establish a wired or a wireless connection.

The computer program of the present invention may run on computing devices 204 or, alternatively, may run on one or more server devices 202. Thus, a first portion of the program, code, or instructions may execute on a first server device 202 or a first computing device 204, while a second portion of the program, code, or instructions may execute on a second server device 202 or a second computing device 204. In some embodiments, other portions of the program, code, or instructions may execute on other server devices 202 as well. For example, information related to unique items may be stored on a memory element associated with the server device 202, such that the information related to unique items is remotely accessible to users of the computer program via one or more computing devices 204. Alternatively, the information related to unique items may be directly stored on the memory element associated with the one or more computing devices 204 of the user. In additional embodiments of the present invention, a portion of the information related to unique items may be stored on the server device 202, while another portion may be stored on the one or more computing devices 204. The various actions and calculations described herein as being performed by or using the computer program may actually be performed by one or more computers, processors, or other computational devices, such as the computing devices 204 and/or server devices 202, independently or cooperatively executing portions of the computer program.

In certain embodiments of the present invention, the computer program may be embodied in a stand-alone program downloaded on a user's computing device 204 or in a web-accessible program that is accessible by the user's computing device 204 via the network 206. For the stand-alone program, a downloadable version of the computer program may be stored, at least in part, on the server device 202. A user can download at least a portion of the computer program onto the computing device 204 via the network 206. In such embodiments of the present invention, the computer program may be an “application,” such as an “app” for a mobile device. After the computer program has been downloaded, the program can be installed on the computing device 204 in an executable format. The executable form of the program permits the user to access embodiments of the present invention via an electronic resource, such as a mobile “app” or website. For the web-accessible computer program, the user may simply access the computer program via the network 206 (e.g., the Internet) with the computing device 204.

Once the user has access to the electronic resource, via the computer program installed on a user's computing device 204 or the web, certain embodiments may provide for users to create accounts with which to access the electronic resource. The user accounts may be stored within the memory elements of the server 206 or in the associated inventory database. Certain embodiments of the present invention may provide for at least four types of user accounts, including an employee account, a store admin account, a multi-store admin account, and a customer account. Each user account may provide users with unique roles, capabilities, and permissions with respect to implementing embodiments of the present invention. However, such embodiments are provided for exemplary purposes only, and other embodiments of the present invention may include any number and/or any specific types of account as may be necessary to carry out the functions, features, and/or implementations of the present invention. For instance, certain other embodiments may provide for a role-based security feature, such that administrative users, through their administrative accounts, may establish, maintain, and oversee a plurality of different types account. Thus, the administrative users may establish and manage the roles, capabilities, and permissions of each of the different types of accounts.

Returning to the embodiments detailed above with four types of user accounts, the employee account is an account created by or for an employee user who may be an employee of a single retail store and/or multiple retail stores. As will be discussed in more detail below, the employee user may make use of various embodiments of the present invention to accept, upload, and register unique items into the inventory database. In addition, the employee user can facilitate a “checking-out” of customers wishing to purchase unique items from retail stores.

The store admin account is a user account established by or for an administrative user of a single retail store. The administrative user may make use of various embodiments of the present invention to manage the online resource, the inventory database, and associated metrics for a single retail store, as will be discussed in more detail below. In additional embodiments of the present invention, the administrative user may establish and manage the employee and customer accounts, such that the administrative user can add, delete, modify, enable, or disable employee and customer accounts.

The multi-store admin account is a user account created by or for an administrative user of multiple retail stores. The administrative user may make use of various embodiments of the present invention to manage the online resource, the inventory database, and associated metrics across multiple retail stores, as will be discussed in more detail below. In additional embodiments of the present invention, the administrative user may establish and manage the employee, store admin, and customer accounts, such that the administrative user can add, delete, modify, enable, or disable such user accounts.

The customer account is a user account established for a customer user of embodiments of the present invention. The customer user is a user who intends to browse and/or purchase unique items that are registered in the inventory database and that are being marketed and/or sold via the online resource or the brick and mortar retail store.

Although certain details and descriptions provided below discuss certain functions, features, and/or implementations of the present invention being carried out by a particular type of user or user account, it is hereby understood that such descriptions are simply provided for illustrative purposes. Thus, for example, certain functions described below as being performed by an employee user may likewise be performed by an administrative user, and such is similarly applicable to other types of users and user accounts as may be required.

Regardless of the type of user account created, each user with an account may be required to enter, or have entered, various pieces of identification information, such as email address, name, home address, date of birth, sex, or the like. In addition, the user may be required to enter or will otherwise be provided with a username and password, which may be required for the user to login to the user's account and access the electronic resource. All information entered by the user is received, via the network 206, and may be stored on the server device 202 or associated inventory database.

Although certain embodiments of the present invention may require a user to establish an account, certain other embodiments may provide for certain features of the present invention to be utilized, such as browsing the inventory database for unique items, without requiring the establishment of a user account. For instance, a potential customer may access the online resource, such as an online website, and browse the unique items available for purchase without needing to register or create an account.

### Inventory Management

Embodiments of the present invention provide for the managing, marketing, and selling of unique items that are registered in an inventory database. Before unique items can be marketed or sold, they must first be registered in the inventory database. Registration of a unique item begins when a unique item is received by a retail store. Once the unique item has been physically received (by being donated, by being sold, or by other applicable means of receipt), in certain embodiments of the present invention an employee user of embodiments of the present invention will register the unique item into the inventory database. In such embodiments, the employee user may use a computing device 204, such as a wireless mobile device (e.g., smartphone, tablet, FDA), to register the unique item to the inventory database.

To begin, the employee user may be required to log-in to the employee's employee account on the computing device 204. Once logged-in, the employee user may use the computing device to register the unique item to the inventory database by initially assigning a unique identifier to the unique item. The unique item corresponds to the registration of the unique item within the inventory database. The unique identifier may include a bar code, a quick resource (QR) code, a radio frequency identification (RFID) tag, or the like. In certain embodiments, the unique identifiers may be pre-manufactured and purchased from third-party sellers of unique identifiers. However, in other embodiments, the unique identifiers may be created on-demand via embodiments of the present invention, such as through a printer and/or other computing devices 204. Once the unique identifier has been assigned to the unique item, the employee user may physically attach the unique identifier to the unique item. As can be appreciated then, the unique identifier can be used to not only identify the unique item, but it can also be used to point to or reference a registration of the unique item within the inventory database.

In addition to simply identifying unique items that have been registered in the inventory database, the inventory database may further include attribute information, discussed in more detail below, which can be used to describe and detail various attributes and/or characteristics of the unique items registered in the inventory database. For example, the employee user may use a computing device to scan the unique identifier attached to the unique item and attribute information related to the unique item may be transmitted via the network from the inventory database and displayed on the employee user's computing device. In additional embodiments, the unique identifier may itself encode some attribute information regarding the unique item, such that some attribute information may automatically be read from the unique identifier and does not require to be transmitted from the inventory database.

As just stated, attribute information of the unique item can be assigned to the unique item and stored in the inventory database. Certain attribute information may be considered default attribute information and may be entered automatically by embodiments of the present invention. For instance, information such as a date, time, store location, unique item ID number, and employee user information may all be assigned to the unique item automatically upon the unique item being registered in the inventory database. The attribute information may also include image and/or videos of the unique items. The employee user may use a computing device to capture an image and/or video of the unique item and transmit, store, and manage/edit the image and/or video to the inventory database. As will be discussed in more detail below, the image and/or video may be presented via the online resource to market the unique item to potential customer users, such that the customer users can visually inspect the unique item before deciding whether or not to purchase it. In certain embodiments in which the unique item was integrated as part of a larger structure before being donated or sold, an image and/or video of the unique item before it was removed from the larger structure may be obtained and assigned to the unique item. For example, if the unique item was a bay window that was removed from a demolished home, an image and/or video of the bay window installed in the home, before the window was removed and the home was demolished, may be captured and stored in the inventory database. Such an embodiment provides for customers users to view what the bay window normally looks like as it is installed in a home.

The attribute information may also include material categories to which the unique items are assigned. Embodiments of the present invention may provide for the employee user to select a material category for the unique item. In certain embodiments, there may be a predetermined list of material categories from which to assign the unique item. For instance, the unique item may be a refrigerator, such that the employee user may select for the unique item to be assigned to an “appliance” category. On the other hand, the unique item may be chandelier, such that the employee user may select for the unique item to be assigned to a “light fixture” category. In additional embodiments, the attribute information may include subcategories, which may further refine the grouping of unique items. For instance, in the refrigerator example provided above, the refrigerator may be assigned to the “kitchen” subcategory, such that the refrigerator is listed in the “appliance” category and “kitchen” subcategory. In certain other embodiments, there may not be a predetermined list of material categories from which the employee user can select, and the employee user may thus be required to manually enter a material category for the unique item to be assigned.

In additional embodiments, the attribute information may include descriptive “tags” that are indicative of the end use of the unique items. For instance, the descriptive tags may indicate that particular items should be used for either indoor or outdoor applications, that the item is rated for use for particular projects, or some similar end-use characteristic. Certain embodiments may include a predetermined list of descriptive tags from which the employee user can select and assign to the unique item. However, in certain other embodiments, the employee user may manually enter the descriptive tags to be assigned to the unique items. Embodiments of the present invention may also include a feature of adding often-used descriptive tags to the predetermined list. For example, if an employee user has registered multiple exterior lights that are registered with the descriptive tag “outdoor use,” then the tag “outdoor use” may be added to the predetermined list, such that the employee user is not required to manually input the descriptive tag each time such an exterior light is registered.

In addition, the attribute information may include a price and a condition of the unique item. For instance, the employee user may enter, via the computing device, the price to be associated with the unique item. The price may be entered manually, or in certain embodiments the electronic display of the present invention may include a slider feature that allows the employee user to manipulate a graphical sliding scale, via a GUI on the electronic display of the computing device. The graphical sliding scale may permit the employee user to quickly and precisely assign a price that is appropriate for the unique item. Further, the employee user may enter the condition of the unique item. For instance, the employee user may select from a predetermined list of potential conditions, such a “poor”, “average”, “excellent”, or the like. In addition, the employee may input the condition of the unique item using as free-form description, in which the employee user can manually enter the condition or other related description information. For attribute information that may be entered manually, such as the category or condition, embodiments of the present invention may provide for the use of speech recognition software, such that the employee user may speak into a microphone of the computing device, and the employee's spoken words are converted to text, which is then entered into a free-form description and saved in the inventory database as part of the attribute information.

Further, the attribute information may include an estimated date of availability and location for the unique item to be purchased. The employee user may select and enter the estimated date of availability and the location via the computing device. The estimated date of availability is a date and/or time on which the unique item may be available to be marketed and sold by a retail store. In certain embodiments, the unique item may be available to be marketed and sold immediately upon the unique item being registered in the inventory database. However, in other embodiments, the employee user may manually input an estimated date of availability that is different from the date on which the unique item was registered in the inventory database. In addition, if the location where the unique item is being sold is different from the location where the employee user registered the unique item, then the employee user may manually input and/or update such location.

The employee user may also enter provider information to be assigned as attribute information of the unique item. Such provider information may include whether the unique item was purchased, donated, or otherwise provided to the retail store. It may also include the purchase price and identification information of the provider of the unique item. As will be discussed in more detail below, additional embodiments of the present invention may provide for coupons, discount codes, advertising banners, advertising opportunities, or other incentive offers to be provided to providers who sell, donate, or otherwise provide unique items to retail stores. Such incentive offers may be sent electronically, such as through email or social networking sites, and may be used to market or otherwise bring attention to the benefits of recycling and/or reusing unique items.

The attribute information may also include a weight of the unique item. The employee user may enter the weight of the unique item via the computing device. The weight may be entered manually, or in certain embodiments, the electronic resource of the present invention may include a slider feature that allows the employee user to manipulate a graphical sliding scale via the GUI of the electronic display of the computing device. The graphical sliding scale may permit the employee user to quickly and precisely assign a weight for the unique item. In certain additional embodiments of the present invention, the weight information for the unique item may be automatically transmitted to the inventory database from a digital scale connected to the inventory database through the communications network 206. In certain embodiments, an application program interface (API) may be used to facilitate communication between the digital scale and the inventory database.

Once the unique identifier has been assigned to the unique item and the attribute information has been entered and stored in the inventory database, the unique identifier can be used to identify the unique item and to obtain attribute information regarding the unique item. As an example, a customer user that is shopping for kitchen sinks at a brick and mortar retail store may use a digital camera on a computing device to scan a unique identifier that is attached to a kitchen sink being displayed for sale at the retail store. Because the kitchen sink's unique identifier corresponds to the sink's attribute information stored in the inventory database, the customer user can implement the electronic resource, via a computing device, to query the inventory database to obtain the attribute information associated with the kitchen sink. In such an example, the online resource is embodied in either a mobile app installed on the customer's computing device or an online website accessible via the customer user's computing device. Thus, through the electronic display of the customer user's computing device, the customer user can view attribute information for the kitchen sink, including a price, condition, category, location, or other pertinent information that may assist the customer user in making a decision as to whether or not to purchase the kitchen sink. In addition, embodiments of the present invention provide for users to forward attribute information to other users or social media outlets for other persons or entities to review. In certain embodiments, the attribute information may be directly forwarded. However, in other embodiments, a uniform resource link (URL) may be forwarded that includes a link for other persons or entities to connect to view the attribute information via the electronic resource of embodiments of the present invention.

As described above, certain embodiments of the present invention provide for all attribute information of a unique item to be entered by the employee user as the unique item is registered. However, additional embodiments of the present invention may provide for the unique item to be quickly pre-registered without entering all of the attribute information at the time of registration. In such an embodiment, the employee user may assign a unique identifier to the unique item, such that the unique item is registered in the inventory database; however, some or all of the attribute information may be entered at a later time. Such an embodiment may be beneficial, for instance, when a retail store receives a large number of unique items that must each be registered. In such a situation, a unique identifier can be quickly attached to each unique item and the unique items can be temporality stored in a staging area where the full attribute information can be assigned at a later time.

As will be discussed in more detail below, embodiments of the present invention provide for customer users to search for and review attribute information stored in the inventory database. However, embodiments of the present invention further provide for employee and/or admin users to select whether or not such attribute information is displayed. Thus, although a unique item has been registered in the inventory database, certain embodiments may provide for attribute information associated with a unique item to be withheld from being available for display to certain users, such as customer users, until so selected by the employee and/or administrative user.

Once the unique identifier and attribute information have been assigned and the unique item has been registered in the inventory database, embodiments of the present invention provide for employee and administrative users to manage inventory, sales, weights, and other related metrics of all of the unique items registered in the inventory database. For example, single retail store embodiments of the present invention may provide the real-time monitoring of each unique item currently in a single retail store's inventory. In addition, embodiments of the present invention provide for a single retail store to track all sales of unique items that have been sold from their inventory. The sale of unique items will be discussed in more detail in the following section titled Marketing and Sales. Embodiments of the present invention thus provide for administrative users of single retail stores to monitor standard sales metrics such as daily, monthly, and yearly sales statistics. In addition, employee and admin users can monitor account payable information that comprises the money currently owed to the retail stores from items purchased via electronic payments from both online or brick and mortar retail stores.

In addition, embodiments of the present invention may provide for administrative users of single retail stores to obtain and review more specialized metrics, such as which unique items are best-sellers and which items are poor-sellers. In even further embodiments, the administrative users may obtain and review metrics associated with attribute information of unique items that have been marketed and/or sold. For instance, the administrative users may determine that certain categories, or subcategories, of unique items are top-sellers. In addition, the administrative user may determine that unique items within certain price ranges sell better than unique items in other price ranges. However, such attribute information metrics are provided for purely illustrative purposes, and embodiments of the present invention provide for retail stores to obtain and review metrics associated with all attribute information associated with unique items. Embodiments of the present invention also provide for sales metrics to be exported to accounting and reporting software, such as Quicken, Quickbooks, or the like. Such exporting may be provided via an API that facilitates an automated transfer of the sales metrics and other related information to the accounting software. The metrics and/or related information may further be exported in data formats that allow for uploading and manipulation of the metrics and/or information, such as MS Excel™, MS Access™, or the like.

Although the inventory and sales metrics listed above were provided with reference to single retail stores, such metrics can similarly be obtained for and used by multiple retail stores via multi-store embodiments of the present invention. In addition, multi-store embodiments of the present invention may provide for employee and/or administrative users to analyze inventories across multiple retail stores. For instance, upon receipt of a particular unique item, an administrative user of multiple retail stores can review inventory and sales metrics to determine if the particular unique item should be transported to and sold from a particular store of the multiple retail stores. Such a determination may be based on criteria such as the particular store currently having a low inventory of the particular item or the particular store having a history of quickly selling unique items similar to the particular unique item. In addition, the administrative user of multiple retail stores can track specialized metrics across the multiple stores, such as which stores are top-sellers and which are poor-sellers. Further detailed analysis can also be performed by analyzing metrics associated with the attribute information of unique items that were sold across the multiple retail stores. For instance, administrative users of embodiments of the present invention may determine if a particular category, or subcategory, of unique items sell better in a particular store or in a group of retail stores situated in a particular geographic area.

Embodiments may additionally provide for users of embodiments of the present invention to aggregate inventory and sales information from single retail stores or across multiple retail stores to generate new, unique, and/or individualized metrics. For instance, if an administrative user determines that a particular type of inventory or sales information is useful, then certain embodiment may provide for the administrative user to generate new, personalized metrics that utilizes the particular type of information. In such embodiment, the new metrics may become standardized such that they become part of the permanent functionality of embodiments of the present invention.

As described above, embodiments of the present invention provide for the tracking of weights of unique items via attribute information obtained and entered by employee users during registration. Embodiment of the present invention thus provide for a determination as to a total weight of all unique materials that have been donated or sold to retail stores rather than being sent to landfills, destroyed by incinerators, or the like. Thus, embodiments of the present invention provide for employee and/or administrative users to obtain and review weight metrics, such as the total and/or estimate weight of 1) unique items currently in the inventory database of either a single retail store or multiple retail stores, 2) unique items brought in and added to the inventory database over a specified time period, 3) unique items sold and removed from the inventory database over a specified time period, or 4) other similar weight-related metrics.

### Marketing and Sales

Once a unique item has been registered in the inventory database, embodiments of the present invention provide for the unique item to be immediately available to be marketed and sold via the electronic resource or from the brick and mortar retail store. In general, the marketing of unique items is accomplished by presenting the attribute information of the unique items on an electronic display of a computing device. The attribute information may be presented to the computing device from the inventory database via the electronic resource, such as a website or mobile application. Because the unique items are instantly registered to the inventory database, embodiments of the present invention provide for real-time updating and management of the unique items that are available to be marketed. Embodiments of the present invention further provide for customer users to access the electronic resource via a computing device to search for one or more unique items. The electronic resource provides multiple search criteria for customer users to search for and locate a unique item that they are looking to purchase.

In single retail store embodiments of the present invention, a customer user can search, via the online resource, for unique items included in the inventory database of a particular single retail store. The customer user can perform a search based on search criteria that may be based on any of the unique item attribute information, such as condition, price, category, subcategory, description, location, etc. For example, a customer user that is shopping for a kitchen sink can access the online resource and manipulate a pull-down menu from which the user may select a “kitchen” category, which lists all unique items included in the inventory database of the single retail store that are included in the kitchen category. In addition, embodiments of the present invention may provide for word-based searches, such that the customer user may enter a descriptive word and/or phrase that can be searched for in the inventory database. For example, the customer user may enter the terms “sink” AND “KOHLER”, such that the search will return all unique items included in the inventory database of the single retail store that include the terms “sink” AND “KOHLER” in their attribute information.

Further embodiments of the present invention provide for searches based on multiple search criteria. In such an embodiment, a customer user can simultaneously search for unique items based on matching multiple pieces of attribute information, including for instance condition, price, category, subcategory, description, location, etc. For example, a customer user may search for all unique items in the kitchen category and that are priced between $100 and $200. Thus, the search will return all unique items included in the inventory database for the particular single retail store and that are include in the kitchen category and that are priced between $100 and $200. Embodiments of the present invention may also provide for search criteria to be saved as a “favorites” search. In such an embodiment, the customer user would not need to re-enter the search criteria each time the customer user wanted to execute a search. Thus, keeping with the example given above, if the customer user chose to add the search of all kitchen category unique items priced between $100 and $200 to her favorites search, then the customer user would not to reenter such information each time she wanted to perform a search for kitchen items priced between $100 and $200. The customer user would simply select or highlight the favorites search, via the GUI of the computing device, and the search would be immediately performed.

In multiple retail store embodiments of the present invention, customer users can use similar search functionalities as were described above for single retail store embodiments. In addition, however, customer users may perform multi-store searches, in which unique items are searched for across multiple retail stores. For example, given the search example provided above in which the customer user searched for unique items in the “kitchen” category, multiple retail store embodiments may provide for the customer user to search for all unique items included in the “kitchen” category that are available across multiple retail stores. Embodiments further provide for the customer user to restrict the search to specified retail stores included in the multiple retail stores. For instance, the customer user may restrict the search to only retail stores within a certain geographical area, such as within a specified zip code, city, county, state, or country. In additional embodiments, the customer user may restrict the search to those retail stores that are within a specified distance from a given location. For example, the customer user may request to search for all unique items in the “kitchen” category being marketed from retail stores within a 10 mile radius from the customer user's home address. In addition, embodiments of the present invention may provide for the customer user to access a geo-location or map feature on the electronic display, such that the customer user can interactively search for and select retail stores within a specified geographic area. For example, through the geo-location or map feature, the customer user may highlight an area on a map within which to search for retail stores that are marketing certain unique items. The results of such a search may include a map with a plurality of marking icons that mark the location of the retail stores that were found to match the search criteria.

In addition to searching for unique items, embodiments of the present invention provide for customer users to search for retail stores. Search criteria for retail store searches may include searches based on geographical areas, such as within a specified zip code, city, county, state, or country. In addition, such searches may be performed via the geo-location or map features, as discussed above. Upon a customer user searching for specified retail stores, the results of the search can be displayed in a list, an array, or on a map as discussed above. In addition, the results may be sorted based on criteria, such as distance from a given location, whether the retail store permits in-store shopping, days and/or hours of operation, or the like. After a search has been performed and one or more retail stores have been found, embodiments of the present invention provide for information related to the one or more retail stores to be displayed on the electronic display of the customer user's computing device. Such information may include the retail store's trademark/tradename, physical address, phone number, website address, hours of operation, or the like.

Once a unique item search has been completed for one or more retail stores, embodiments of the present invention provide for attribute information for all of the unique items in the inventory database that match the search criteria entered by the customer user to be presented on the electronic display of the customer user's computing device. The presentation may include the digital image of each of the matched unique items. If a plurality of unique items matches the search criteria, embodiments of the present invention provide for the digital images of the plurality of unique items to be displayed in a list, an array, or other similar method of displaying a plurality of objects on an electronic display. The digital images may be presented in the form of small, thumbnail-type digital images, such that multiple digital images can be simultaneously displayed on the computing device of the customer user.

In certain embodiments of the present invention, the presented digital images may include additional attribute information positioned adjacent to the digital image. Such additional attribute information may include portions of the attribute information stored in the inventory database, such as price, condition, category, subcategory, location, or the like. For instance, in continuing with the example provided above, if a customer user searches for all unique items in the “kitchen” category that are being marketed by one or more retail stores, embodiments of the present invention provide for the display of the digital images and other attribute information of each of the matched unique items that belong in the “kitchen” category. Such unique items and corresponding digital images and attribute information may pertain to sinks, countertops, faucets, cabinets, or the like. The digital images and additional attribute information may further include a hyperlink, such that if the customer user clicks or highlights the image and/or additional attribute information of a particular unique item, a full description of the selected unique item is displayed. The full description may include a large, full-size digital image of the unique item along with all of the attribute information that was entered by the employee user when the unique item was registered into the inventory database.

In addition to the presentation of unique items that were searched for by a customer user, embodiments of the present invention provide for “hand-picked” unique items to be presented to the user's computing device. The hand-picked items may be selected and displayed along with the unique items that were searched for by the customer user and displayed on the user's computing device. Such hand-picked unique items may be unique items that were selected by employee and/or administrative users for marketing purposes. The employee and/or administrative users may select the hand-picked items based on criteria, such as the unique items being of exceptional quality, rare, unconventional, or other subjective criteria. Additional embodiments may provide for a random selection of hand-picked items, such that the hand-picked items are randomly selected from all of the unique items currently in the inventory database. Regardless of the method for selecting the hand-picked unique items, such items may be presented along with the unique items, by listing a digital image and/or other attribute information of the hand-picked items along with a notice that such presented items are hand-picked.

Embodiments of the present invention further provide for the unique items that are presented on a customer user's computing device to be sorted based on a sorting criteria. In certain embodiments, the sorting criteria may include the attribute information, such that the presented unique items can be sorted by category, subcategory, price, condition, keyword, location, or the like. For example, the unique items may be sorted based on price, such that the unique items are presented form lowest-price to highest-price. Further, certain retail stores may only sell unique items either online or in-person from a brick and mortar location. Thus, embodiments of the present invention may further provide for presented unique items to be sorted based on the availability for the unique items to be purchased either online or in-person. In addition, the presented unique items may be sorted based on a geographic location of one or more retail store in which the unique items are located. In such an embodiment, unique items that are being sold from retail stores that are closest to the customer user's home address may be listed first, before unique items sold from retail stores that further from the customer's home address. Additionally, embodiments of the present invention may provide for automatically determining the customer user's current location, via geo-location features (e.g., GPS, IP Address Locator, etc.) of the customer user's computing device. In such an embodiment, the customer user's address can be automatically determined to sort the presented unique items based on the customer user's distance from the one or more retail stores.

If a customer user is unable to find a unique item that meets the customer user's search criteria, embodiments of the present invention may provide for update notices of unique items recently donated or sold to the retail stores to be sent to the customer user. In such an embodiment, the customer user may select certain triggers that identify when an update notice should be provided to the customer user. The triggers may be based on multiple search criteria, including attribute information, retail store location, or the like. For example, if the customer user requires a KOHLER™ brand kitchen sink, then the customer user may set-up an update profile such that if any retail store adds a KOHLER™ branded sink to its inventory database, the customer user is immediately provide with an update notice, such as an email, text message, social media message, or an electronic notice via the electronic resource. The customer user may also combine search criteria, such that only unique items matching all of the search criteria will induce an update to be sent to the customer user. For instance, the customer user may determine that she would like to receive an update if a retail store within 10 miles of her home address receives a KOHLER™ branded sink that is priced under $100.

Upon finding a unique item that the customer user wishes to purchase, embodiments of the present invention provide for the online purchase of the unique item through the electronic resource. In certain embodiments, the online resource may include a “shopping cart” feature in which items that the customer user selected for purchase are identified. The customer user can continue to shop or review other unique items, and the selected unique items will stay in the shopping cart until the customer user chooses to continue with the purchase. Once the customer user has selected all of the unique item(s) for purchase, the user can purchase the unique items online with a credit card, debit card, gift card, coupon, or the like. The user can additionally enter shipping information such that upon purchasing the unique item(s), the unique items(s) can be shipped to the listed address. In certain embodiments, shipping fees and state and/or federal taxes may also applicable and may be applied to the price that is charged to the customer user. After completing the purchase, the customer user may be sent an electronic receipt that identifies a purchase transaction. In certain embodiments the customer user may elect to have the receipt mailed to the customer user's physical home address. In other embodiments, the receipt may be delivered electronically, such as to the customer user's computing device, email, social networking account, or the like. In embodiments where the receipt is in electronic form, the receipt may include an option where certain portions of the attribute information of the purchased unique item is posted to a social networking account of the customer user. Such a feature, along with other social network features, is described in more detail in the next section. Along with the receipt, the customer user may also receive newsletters, advertising/sponsorship banners, coupons, discount codes, or other marketing and incentives offers provided by the retail stores.

Upon purchase of a unique item, embodiments of the present invention provide for the purchased unique item to be immediately unregistered from the inventory database. Thus, the purchased unique item is not available to be marketed via the online resource. In addition, embodiments of the present invention provide for a removal notice to be sent to employee and/or administrative users of the retail store from which the item was purchased. The removal notice informs the employee and/or administrative user that the unique item was purchased and that it should be removed from the floor (i.e., showroom) of the brick and mortar retail store so that it is not purchased or attempted to be purchased by a customer at the retail store. However, even if a customer at the brick and mortar retail store attempts to purchase the already purchased unique item, because the unique item is not registered in the inventory database, upon attempting to purchase the unique item, the computing device of the employee and/or administrative user attempting to “check-out” the customer will emit an alert or error message noting that the unique item has already been purchased and is no longer for sale. Embodiments of the present invention may also provide for hold notices to be sent to employee and/or administrative users. Such hold notices may function as a “temporary” removal notice. For instance, unique items subject to a hold notice will be placed on hold within the inventory database, such that the unique items cannot be sold until the hold notice expires. In addition, upon receiving a hold notice, an employee and/or an administrative user may generate, print off, and physically attach a hold notice identifier, such as a sticker or label, to the unique items, such that users and/or customers can easily identify the unique item as being on hold and thus temporarily unavailable for sale.

In certain other embodiments of the present invention, the unique items in the inventory database may be provided to or displayed on third-party e-commerce sites, such as eBay™, Craigslist™, Facebook™, or the like. In such an embodiment, upon the employee user registering a unique item, the attributes of the unique item, including digital image, price, category, and/or other description information may be sent to the e-commerce site, such that customers of the e-commerce site can purchase the unique item from e-commerce site. In certain embodiments, the attribute information may be sent to the e-commerce site via an API, thus providing for a seamless and automatic flow of information between embodiments of the present invention and the third-party e-commerce sight. In such an embodiment, the retail stores and the third-party e-commerce sites may be required to negotiate and agree to certain distribution of fees and/or percentages of profits relating to the sale of unique items.

In addition to online purchasing, customer user can purchase unique items directly from brick and mortar retail stores. Because each unique item has a unique identifier physically attached to it, a customer user can use a computing device to scan the unique identifier, and embodiments of the present invention provide for attribute information regarding the unique item to be presented on the electronic display of the customer user's computing device. The attribute information may include any or all of the attribute information that was registered with the unique item and saved in the inventory database. Thus, embodiments of the present invention may provide for customer users to browse the unique items in the brick and mortar location and to simultaneously virtually browse the unique items by scanning the unique identifiers to obtain additional detailed information via the online resource.

If a customer user finds a unique item in the brick and mortar retail store that the customer user wishes to purchase, then the customer user simply brings the unique item to an employee user, and the employee user can “check-out” the customer user. For instance, the employee user can scan the unique identifier with the employee user's computing device. Scanning the unique identifier will identify the price of the unique item, and the customer user can purchase the unique item with cash, credit/debit card, coupon, or the like. Embodiments of the present invention may provide for traditional point-of-sale credit card processing machines to be integrated with the system of embodiments of the present invention. In additional embodiments, certain credit card processing systems, such as Square™, may be integrated directly with computing devices, such as mobile phones and/or tablets. Once the unique item has been purchased, the customer users may be given a physical receipt and can then take the unique item or choose to have it delivered to a specified address. In addition, customers that purchase unique items from brick and mortar retail stores may provide their email address or social media profiles to the employee users, such that, as with online purchases, the customers may electronically receive receipts, newsletters, sponsorship/advertising banners, coupons, discount codes, or other marketing and incentive offers.

Regardless of whether the unique item is purchased online or in a brick and mortar retail store, embodiments of the present invention provide for the unique item to be instantaneously removed from the inventory database once the item has been purchased. Thus, upon purchase of a particular unique item, the particular unique item will no longer be available for display or purchase via the electronic resource. In addition, the particular unique item will not be available for purchase at the brick and mortar retail store because upon the employee user scanning the unique identifier of the particular unique item, the employee user's computing device will not find the particular unique item as being registered in the inventory database and will emit an alert or error messaging indicating that the particular unique item is no longer for sale. Such an embodiment provides for unique items to only be purchased once and prevents, for instance, a particular unique item from being purchased at a brick and mortar location and shortly thereafter being purchased online via the online resource.

### Additional Features

In addition to the features described above, embodiments of the present invention further provide for integration with social media, whereby the system and computer program facilitate communication and networking between users, customers, donors, or the like, through social networking sites, such as Facebook™, Twitter™, or the like. For instance, employee and/or administrative users may provide donors that donate unique items to a retail store with coupons, discount codes, gift cards, or other types of incentives via social networking sites. As an example, a donor that donates a refrigerator to a retail store may be sent a $20.00 coupon code with which the donor can redeem for either online through the electronic resource, or in person at the brick and mortar retail store. Before the donor can receive the discount code, the donor may be required to form a relationship with the retail store, such as through “friending”, “liking”, “following”, or other appropriate social networking relationship being formed with the business retail establishment. Once, the appropriate social networking relationship has been formed, the $20.00 discount code may be sent to the electronically to the donor, either through the donor's social networking account, email, text message, computing device, or the like. Thereafter, the donor can redeem the discount code as a customer user by printing off the discount code and bringing the printout to the retail discount store. In addition the donor, as a customer user, may display the discount code to an employee and/or administrative user at the retail business store, by entering the discount code through the online resource, via the computing device. Embodiments of the present invention may include other redemption methods, as appropriate. In addition, embodiments of the present invention may provide for the tracking of discount codes redemptions, so as to measure engagement and usefulness of the incentive programs.

In addition to social media networking, embodiments of the present invention may provide for sellers, donors, or other providers of unique items to receive receipts, either in person or electronically, that identify the unique item as being provided. For instance, if the donor provides an email address, the receipt for the donation may be automatically sent to the donor's email address such that the donor can use the receipt for tax write-off purposes.

Additional embodiments of the present invention may allow for further communications with donors, customers, and the general public, through electronic media and social networking to promote and market the retail stores, to provide education regarding social and environmental benefits of recycling and donating unique items, and to build general awareness of social and environmental issues. Further embodiments of the present invention may provide for sellers, donors, or other providers to purchase or otherwise have access to advertising space located on the retail store's online resource, advertisements, or other electronic communications. Thus, for example, after a donor has donated a unique item to a retail store, the donor may be sent an electronic receipt that instructs the donor how the donor can take part in advertising through the retail store's electronic communications.

Although the invention has been described with reference to the embodiments illustrated in the attached drawing figures, it is noted that equivalents may be employed and substitutions made herein without departing from the scope of the invention as recited in the claims. For instance, although certain embodiments were directed to implementing the present invention for retail store applications, additional embodiments may facilitate inventory management for personal storage or warehouse applications. Embodiments of the present invention may facilitate an individual to manage an inventory of unique-personal items, such as furniture, decorations, kitchenware, clothing, or the like. Thus, if the individual is required to store their unique-personal items in a storage unit, the individual can implement embodiments of the present invention to manage their inventory of items. For example, if an individual is moving residences and is required to place their unique-personal items in a long-term PODS™ storage unit, the individual can use a computing device to obtain digital images of the items and upload the images to the inventory database before the items are placed into storage. The individual can also assign attribute information, as was previously described. Such an embodiment may be beneficial, for instance, to ensure that none of the individual's unique-personal items were lost, damaged, or experienced deterioration during the time they were kept in the storage unit. Embodiments of the present invention thus provide for individuals or other entities to manage inventories of unique items while the items are being stored in storage facilities, warehouses, or the like.

Having thus described various embodiments of the invention, what is claimed as new and desired to be protected by Letters Patent includes the following:

1. A non-transitory computer readable storage medium with an executable program stored thereon for managing inventories of unique items, wherein the program instructs a processor to perform the following steps:
receive information indicative of a request for a new unique item to be registered in an inventory database,
wherein the inventory database has registered therein a plurality of unique items,
wherein the inventory database includes attribute information associated with each of the unique items registered in the inventory database;
assign a unique identifier to the new unique item;
register the new unique item in the inventory database;
receive attribute information corresponding to the new unique item;
provide to a user a set of computer-executable instructions that when executed by a user's computing device, generate a user interface displayable on an electronic display coupled to the user's computing device;
receive information indicative of a request by the user, via the user's computing device, to search the plurality of unique items registered in the inventory database for one or more selected unique items whose attribute information matches a search criteria;
present to the user, via the user interface, attribute information of the one or more selected unique items whose attribute information matches the search criteria,
wherein the attribute information of the new unique item is included in the attribute information of the one or more selected unique items whose attribute information matches the search criteria and is presented to the user; and
receive information indicative of a request for the new unique item to be unregistered from the inventory database,
wherein upon receiving the information indicative of the request for the new unique item to be unregistered from the inventory database, the new unique item is unregistered from the inventory database and the attribute information of the new unique item is no longer available to be presented to the user via the user interface.

2. The computer readable storage medium of claim 1, wherein the attribute information of the unique items registered in the inventory database includes one or more of the following types of information: a category of the unique items, a price of the unique items, digital images of the unique items, a weight of the unique items, and a condition of the unique items.

3. The computer readable storage medium of claim 2, wherein the search criteria includes one or more of the types of information included in the attribute information.

4. The computer readable storage medium of claim 3, wherein the search criteria may further include a geographic location of a retail store where the unique items are located.

5. The computer readable storage medium of claim 1, wherein the unique identifier is comprised of one or more of the following: a bar code, a quick response code, or a radio frequency identification tag.

6. The computer readable storage medium of claim 1, wherein the information indicative of the request to register a new unique item to the inventory database is received from a wireless communications device.

7. The computer readable storage medium of claim 1, wherein the information indicative of the request to unregister the new unique item from the inventory database is received in response to the new unique item being purchased.

8. The computer readable storage medium of claim 1, further including the step of:
receive information indicative of the weight of the new unique item; and
determine the total weight of all of the unique items included in the plurality of unique items registered in the inventory database.

9. A non-transitory computer readable storage medium with an executable program stored thereon for managing inventories of unique items, wherein the program instructs a processor to perform the following steps:
receive information indicative of a request for a new unique item to be registered in an inventory database,
wherein the inventory database has registered therein a plurality of unique items;
assign a unique identifier to the new unique item;
register the new unique item in the inventory database;
provide to a user a set of computer-executable instructions that when executed by a user's electronic device, generate a user interface displayable on an electronic display coupled to the user's electronic device;
present to the user, via the user interface, attribute information of one or more unique items from the plurality of unique items registered in the unique item database,
wherein the attribute information of the new unique item is included in the attribute information of the one or more unique items presented to the user; and
receive information indicative of a request for the new unique item to be unregistered from the inventory database,
wherein upon receiving the information indicative of the request for the new unique item to be unregistered from the inventory database, the new unique item is unregistered from the inventory database and the attribute information of the new unique item is no longer available to be presented to the user via the user interface.

10. The computer readable storage medium of claim 9, wherein the unique identifier is comprised of one or more of the following: a bar code, a quick response code, or a radio frequency identification tag.

11. The computer readable storage medium of claim 9, wherein the information indicative of the request to register a new unique item to the inventory database is received from a wireless communications device.

12. The computer readable storage medium of claim 9, wherein the information indicative of the request to unregister the new unique item from the inventory database is received in response to the new unique item being purchased.

13. The computer readable storage medium of claim 9, wherein the information indicative of the new unique item is comprised of one or more of the following: a category of the unique item, a price of the new unique item, digital images of the unique item, a weight of the unique item, or a condition of the unique item.

14. The computer readable storage medium of claim 9, further including the step of:
receive information indicative of the weight of the new unique item; and
determine the total weight of all of the unique items included in the plurality of unique items registered in the inventory database.

15. A method for managing inventories of unique items, including the steps of:
receiving a request for a new unique item to be registered, via a processor, in an inventory database,
wherein the inventory database has registered therein a plurality of unique items,
wherein the inventory database includes attribute information associated with each of the unique items registered in the inventory database;
assigning, via the processor, a unique identifier to the new unique item;
registering, via the processor, the new unique item in the inventory database;
receiving attribute information corresponding to the new unique item;
providing to a user a set of computer-executable instructions that when executed by a user's computing device, generate a user interface displayable on an electronic display coupled to the user's computing device;
receiving a request by the user, via the user's computing device, to search, via the processor, the plurality of unique items registered in the inventory database for one or more selected unique items whose attribute information matches a search criteria;
presenting to the user, via the user interface, attribute information of the one or more selected unique items whose attribute information matches the search criteria,
wherein the attribute information of the new unique item is included in the attribute information of the one or more selected unique items whose attribute information matches the search criteria and is presented to the user; and
receiving a request for the new unique item to be unregistered, via the processor, from the inventory database,
wherein upon receiving the information indicative of the request for the new unique item to be unregistered from the inventory database, the new unique item is unregistered from the inventory database and the attribute information of the new unique item is no longer available to be presented to the user via the user interface.

16. The method 15, wherein the attribute information of the unique items registered in the inventory database includes one or more of the following types of information: a category of the unique items, a price of the unique items, digital images of the unique items, a weight of the unique items, and a condition of the unique items.

17. The method claim 16, wherein the search criteria includes one or more of the types of information included in the attribute information.

18. The method of claim 17, wherein the search criteria may further include a geographic location of a retail store where the unique items are located.

19. The computer readable storage medium of claim 15, wherein the unique identifier is comprised of one or more of the following: a bar code, a quick response code, or a radio frequency identification tag.
